(19) United States
(12) Patent Application Publication
(10) Pub. No.: US 2006/0155572 A1
(43) Pub. Date: Jul. 13, 2006

(54) Methods and systems for buying, selling and trading intellectual property and other interests

(76) Inventor: Richard Postrel, Miami Beach, FL (US)

Correspondence Address: ANTHONY R. BARKUME, 20 GATEWAY LANE, MANORVILLE, NY, 11949, US

(21) Appl. No.: 11/330,723

(22) Filed: Jan. 12, 2006

Related U.S. Application Data
(60) Provisional application No. 60/643,395, filed on Jan. 12, 2005.
(60) Provisional application No. 60/667,195, filed on Mar. 31, 2005.

(51) Int. Cl. G06Q 99/00

(52) U.S. Cl. 705/1

(57) ABSTRACT

A method of assigning value to intellectual property such as a patent application. First, a starting price for the intellectual property is determined prior to undergoing a prosecution phase. A price modifier is then associated with each of a number of various prosecution factors, with each prosecution factor related to a stage of prosecution of the application. A value of the patent application is then calculated, at any time during prosecution (or after) by adjusting the starting price by a price modifier associated with a stage of prosecution that occurs for the application. This intellectual property valuation methodology may for example be implemented in an online intellectual property exchange over a computer network such as the Internet, where intellectual property (or shares in intellectual property) may be purchased, exchanged, sold, pooled, etc.

### CROSS-REFERENCE TO RELATED APPLICATION

This application claims filing priority of co-pending U.S. provisional patent application Ser. No. 60/643,395 filed on Jan. 12, 2005; and co-pending U.S. provisional patent application Ser. No. 60/667,195 filed on Mar. 31, 2005.

### BACKGROUND OF THE INVENTION

The present invention relates to systems and methods for buying, selling and trading intellectual property, as well as providing a valuation of intellectual property prior to its grant or issuance.

Intellectual property, such as patents, patent applications, trademarks, trademark application, copyrights, as well as licenses for practicing under such intellectual property are intangible property with attributes of personal property. Thus, intellectual property may be bought and sold freely between willing parties for whatever price is negotiated. Determination of the value of intellectual property, in particular of an issued patent is difficult due to many factors such as market conditions, product developments and improvements, the strength of the patent, etc. Determination of the value of a pending patent application is even more problematic due to the uncertainty over when the patent application may mature into an issued patent, the strength of the claims that may issue, etc.

The present invention provides methodologies for buying, selling and trading in intellectual property, in particular patents and patent applications. In one embodiment, the price of a patent application is based on various factors that occur during prosecution of a patent application in order to determine the value of the application or the issued patent. In another embodiment, options are made available for a certain time period during which buyers may acquire the right to purchase or license intellectual property or a percentage unit of the intellectual property for a specific period of time at a predetermined price.

### SUMMARY OF THE INVENTION

The present invention is a valuation methodology and system for intellectual property such as patent applications that is based upon one or more of various stages of the patent prosecution process. A patent application undergoes various phases from the time it is filed until the time that it matures into a patent or is otherwise disposed of. Some of these phases are regarded as being positive, such as an indication of allowance of claims by the Examiner, and some of these phases are regarded as negative, such as rejection of claims by the Examiner. In addition, the magnitude of a positive or a negative factor may be varied in accordance with the situation. Thus, a rejection of claims on the basis of prior art may have a strong negative factor, while the rejection of claims on the basis of format only may have a relatively weak negative factor. These prosecution stages are difficult to predict with any certainty, yet will weigh heavily on the ultimate value of the patent that issues from the application. Therefore, the present invention implements a predetermined methodology that assigns relative values to a patent application based on the stages, phases or milestones reached during prosecution.

Thus, the present invention is a method of assigning value to intellectual property such as but not limited to a patent application. First, a starting price for the intellectual property is determined prior to undergoing a prosecution phase (such as in the United States Patent and Trademark Office). A price modifier is then associated with each of a number of various prosecution factors, with each prosecution factor related to a stage of prosecution of the application. A value of the patent application is then calculated, at any time during prosecution (or after) by adjusting the starting price by a price modifier associated with a stage of prosecution that occurs for the application.

For example, the stages of patent application prosecution may include the following:
A first office action
   with all claims rejected,
   with all claims allowed, or
   with some claims allowed and some claims rejected
      based on prior art reasons, or
      based on formal reasons.
A response filed after an office action
   with some claims allowed and the rejected claims cancelled,
   with some claims allowed and the claims rejected on prior art reasons amended and/or argued, or
   with some claims allowed and the claims rejected on formal reasons amended and/or argued.
A second office action
   with the previously rejected claims allowed and the application ready for allowance, or
   with the rejected claims under final rejection.
A second response filed with the rejected claims cancelled and the application has some allowable claims;
An appeal being filed.
A continuation application being filed.
All claims allowed.
An appeal filed
   decided in favor of patentability, or
   decided not in favor of patentability.

In addition to the factors related to prosecution of the patent application as exemplified above (referred to as intrinsic factors), the price of the patent application may be modified by other external or extrinsic factors, such as market conditions, new inventions or discoveries in the same or a related field, press coverage of the subject invention, economic factors relevant to the subject invention, and the like.

The present invention may be carried out in association with an intellectual property (IP) exchange over a computer network. The IP exchange would have a server computer interconnected to the computer network, the server computer having means for storing intellectual property listings, each of the listings having a description of intellectual property being offered for sale and a sales price ascertained in accordance with the value assigning methodology described above.

The intellectual property exchange further includes a number of client computing devices interconnected to the network in selective communication with the server computer, wherein each client computing device allows an associated user to access the intellectual property listings and determine the associated sales price ascertained in accordance with the value assigning steps.

A user is enabled to place an offer with the server computer to purchase the intellectual property listed thereon or a share of one or more pieces of intellectual property listed thereon.

### BRIEF DESCRIPTION OF THE DRAWING

FIG. 1 is a flowchart of the valuation process of the present invention; and

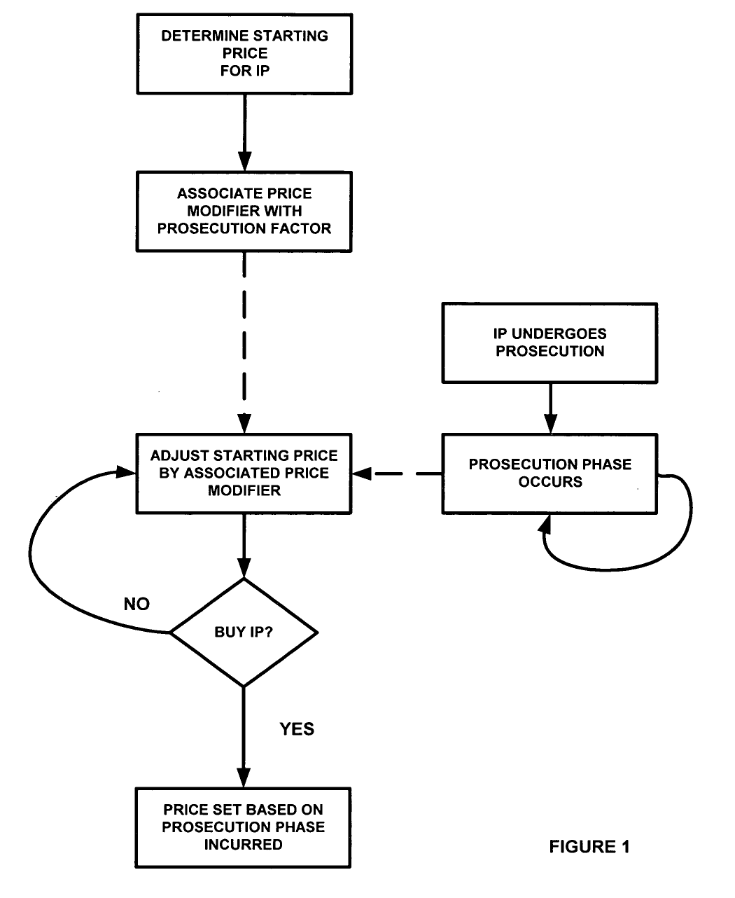

FIG. 2 is a block diagram of the IP exchange network of the present invention.

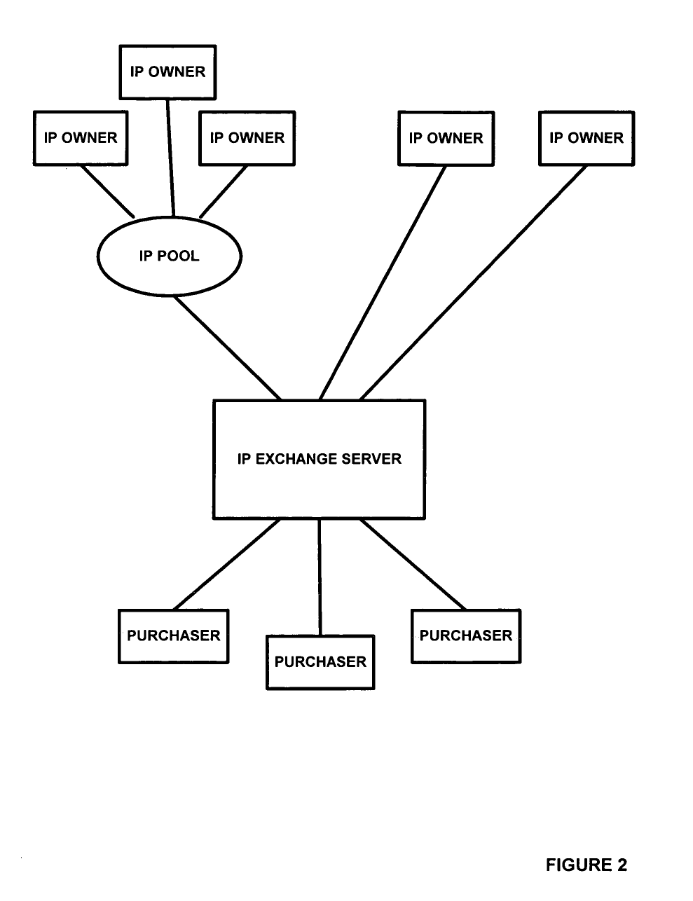

### DETAILED DESCRIPTION OF THE PREFERRED EMBODIMENT

With reference to the Figures, the selling price SP of an item of intellectual property such as a patent application will be determined based upon a starting price ST. The preferred embodiment is described with respect to a United States patent application but has applicability to any intellectual property that undergoes an examination, prosecution or registration process. The starting price may be determined by reference to a set of rules, algorithms or regulations that may be based on factors including but not limited to the size of the relevant market, the number of target applications, investment costs, research and development costs, product development costs, etc.

A set of price modifiers are then determined and associated with a set of patent application prosecution factors. Each prosecution factor is associated with a stage of prosecution of the application. For example, the preferred embodiment of the invention utilizes the following prosecution factors:

| | |
|---|---|
| First Office action | |
| All claims allowed | +ACA |
| All claims rejected | −ACR |
| X claims allowed | +X(A) |
| Y claims rejected based on prior art reasons | −Y(R) |
| Z claims rejected based on formal reasons | −Z(FR) |
| Response filed if necessary | |
| Some claims allowed, rejected claims cancelled | +PA |
| Some claims allowed, claims | +CA |
| Rejected on prior art reasons amended and/or argued | |
| Some claims allowed, claims | +FA |
| Rejected on formal reasons | |
| Amended and/or argued | |
| Second Office action if necessary | |
| Rejected claims allowed - case | +ACA |
| Ready for allowance | |
| Rejected claims under final rejection | −FR |
| Response filed if necessary | |
| Rejected claims cancelled - case has some allowable | +RCC |
| claims | |
| Appeal filed | −AF |
| Continuation application filed | +C |
| Appeal Brief filed by applicant | +APB |
| Appeal decided favorably to applicant | +APF |
| Appeal decided unfavorably to applicant | −APU |

The above provides example of factors that may be assigned to the various stages of patent prosecution. Each factor may have a multiplier that may be agreed to by the parties (or unilaterally set by the application owner or service provider) prior to prosecution of the application. Thus, the seller and the buyer may enter into a contract for sale of the application where the price is determined by the above factors as prosecution proceeds. The parties may agree to execute the sale at a certain date, or after a certain time has elapsed, or when certain milestones are reached, etc.

Premiums and/or discounts on the sales price may be established based on desirability of the patent property, market demand, as well as other various factors.

A secondary market may exist wherein patent properties may be made subject to processes such as liquidation, contango, arbitrage, and the like.

For example, Smith and Jones agree to enter into a contract of sale for a patent application being prepared by Smith and his attorney. Jones agrees to purchase or license the application from Smith at any time selected by Jones but no later than three years after the date the application has been filed. The parties agree to the following price factors:

| | | |
|---|---|---|
| Starting price ST | | $1,000,000 |
| First Office action | | |
| All claims allowed | +ACA | $2,000,000 |
| All claims rejected | −ACR | ($500,000) |
| X claims allowed | +X(A) | X $100,000 |
| Y claims rejected based on | −Y(R) | Y($100,000) |
| prior art reasons | | |
| Z claims rejected based on | −Z(FR) | Z($50,000) |
| formal reasons | | |
| Response filed if necessary | | |
| Some claims allowed, rejected | +PA | $1,000,000 |
| claims cancelled | | |
| Some claims allowed, claims | +CA | $500,000 |
| rejected on prior art | | |
| reasons amended and/or argued | | |
| Some claims allowed, claims | +FA | $800,000 |
| Rejected on formal reasons | | |
| amended and/or argued | | |
| Second Office action if necessary | | |
| Rejected claims allowed - case | +ACA | $900,000 |
| ready for allowance | | |
| Rejected claims under final rejection | −FR | ($500,000) |
| Response filed if necessary | | |
| Rejected claims cancelled - case | +RCC | $700,000 |
| has some allowable claims | | |
| Appeal filed | −AF | $100,000 |
| Continuation application filed | +C | $200,000 |
| All claims subsequently allowed | +AA | $1,000,000 |
| Appeal Brief filed by applicant | +APB | $300,000 |
| Appeal decided favorably to applicant | +APF | $500,000 |
| Appeal decided unfavorably to applicant | −APU | ($500,000) |

In this example, one year after Smith files the application with 27 claims, an Office action is received that allows 15 claims, rejects 7 claims on prior art reasons, and rejects 5 claims on formal reasons. If Jones opts to purchase the application at that time, the price would be:

$$\begin{matrix}SP = ST + [ X \$100 \text{,} 000 ] - [ Y \$100 \text{,} 000 ] - [ Z \$50 \text{,} 000 ] \\ = \$1 \text{,} 000 \text{,} 000 + [ 15 \times \$100 \text{,} 000 ] - [ 7 \times \$100 \text{,} 000 ] - [ 5 \times \$50 \text{,} 000 ] \\ = \$1 \text{,} 000 \text{,} 000 + \$1 \text{,} 500 \text{,} 000 - \$700 \text{,} 000 - \$250 \text{,} 000 \\ = \$1 \text{,} 550 \text{,} 000\end{matrix}$$

In the event that all claims had been initially allowed, then the selling price would have been $3,000,000. In the event that all claims had been initially rejected, then the selling price would have been $500,000.

Continuing with the example, Jones does not purchase the application but elects to wait longer. Smith proceeds to file a response to the Office action in which the claims that were rejected on prior art reasons are amended and the claims rejected on formal reasons are amended. The selling price is now:

$$\begin{matrix}SP = \$1 \text{,} 550 \text{,} 000 + \$500 \text{,} 000 + \$800 \text{,} 000 \\ = \$2 \text{,} 850 \text{,} 000\end{matrix}$$

After several months a subsequent action is issued by the Examiner, which allows all pending claims. The selling price is now:

$$\begin{matrix}SP = \$2 \text{,} 850 \text{,} 000 + \$1 \text{,} 000 \text{,} 000 \\ = \$3 \text{,} 850 \text{,} 000\end{matrix}$$

If, instead of allowance, the claims were rejected an the case proceeded to appeal, then the selling price would have been $2,950,000 after the appeal is filed and then $3,250,000 after the appeal brief is filed. If the appeal were then decided favorably, then the selling price would increase to $3,750,000; if decided unfavorably then it would decrease to $2,750,000.

In addition to the factors related to prosecution of the patent application as exemplified above (referred to as intrinsic factors), the price of the patent application may be modified by other external or extrinsic factors, such as market conditions, new inventions or discoveries in the same or a related field, press coverage of the subject invention, economic factors relevant to the subject invention, and the like.

This methodology is easily applied to a license scenario as well. Additional terms would be applied, such as term of the license and field of use. The consideration for the license, including annual minimum royalties, periodic running royalties, lump sum royalties, etc. would vary in a similar manner as above.

As can be seen from the above example, the buyer and seller, by using the formulations provided, can eliminate some of the uncertainty and guesswork in arriving at a sales or license price for the patent application during prosecution of the application. The buyer can elect to purchase the application at any time subject to the formulations provided. As events occur that increase the likelihood of allowance, then the price is increased, and vice versa. The same methodology may apply to the prosecution of trademark applications, where pricing factors are assigned such as the application being based on actual use or an intent to use, the existence of related marks, rejections based on likelihood of confusion or other factors, allowance of the application, etc.

In a second aspect of the invention, an intellectual property exchange is setup, preferably for online use. A user/investor may log into a web site in which he is able to select intellectual property such as a patent application in prosecution, and purchase a share or unit of that patent application, an issued patent, or a license to that application or patent. The user/investor may for example be interested in investing in a biotechnology patent application or body of applications and/or issued patents based on his interest in that field. The user may access a database such as the database at the USPTO web site that enables the user to access publicly available records related to issued patents and pending applications that have been published (usually 18 months after filing under current laws). The user may uncover an application of interest and then navigate to the online exchange site to determine if it is available for investment.

In the alternative, the user may discover intellectual property such as patents and applications via the online exchange web site directly, for example a section may be devoted to displaying the availability of patents and patent applications. Collateral information may be made available via the web site to assist the user in making investment decisions. Third parties may also be involved in the process; for example an independent broker or agent may provide an online research tool that will enable a user to learn about available patent properties as described above.

Assuming that the application is available for investment, the user/investor is provided with a share or unit price that represents a percentage of ownership in the property. Thus, he may for example be able to purchase one share out of 10,000 available shares for the share price of $500, where the patent application has been valued at $5,000,000. Shares in license to such intellectual property may be obtained in a similar manner. This is an investment vehicle with a value that may rise or fall as they value of the patent application rises or falls based on one or more factors.

Factors that may influence the value of the patent application include market conditions as well as the stage of prosecution that he application may be in, as provided for example in the first aspect of the invention described above. Generally speaking, as more claims are given favorable consideration, the value of the application will likely increase. The formulation used to value a given patent application during its prosecution may or may not be made publicly available. Thus, the user may have to do his own market analysis based on publicly available information as to the status of the patent application, made known for example on the USPTO web site.

Market makers may operate to establish margins wherein the patent property may be purchased at a first price and then sold at a second price.

Valuations may be made by third party experts in various fields, such as the relevant market of the intellectual property, technology experts, business experts, etc. These independent valuations may be made accessible to potential investors via the online exchange web site (fees may be charged if desired).

Hedge funds may be implemented under the present invention to enable future liabilities to be hedged by participating at a low rate (e.g. by taking an option or small percentage share in a property and determine how the market unfolds before making larger investments.

Options may be bought and sold online on the exchange, including puts and calls on such options.

In addition to investing in one particular patent application, an investor may be able to invest in a pool of patent applications, issued patents, and/or licenses to same, both US and abroad. A company (or multiple companies) may pool all or a portion of its patent properties into a single investment vehicle and sell shares as described above. For example, the company may be developing a new technology and have 5 patent applications pending, and determine the value to be $20,000,000. It may sell 10,000 shares to purchase or license, each at a price of $2,000. As mentioned above, the investor would be able to ascertain any information on these filings by reviewing a publicly available database. The company may also decide to publish details of the prosecution history independent of the USPTO web site, for example on the company web site that may be linked to the exchange web site. In this case, the investor may obtain further information by simply navigating the appropriate web sites and then make an investment decision accordingly.

The investor would at a later time be able to sell his shares in any given patent application or pool of patent properties or licenses via the online exchange web site, similar to other type of stock or securities transactions as known in the art.

Inventors, their assigns or agents may be able to have their patents and applications listed on the exchange service for a fee, which may be fixed, percentage, contingent, etc.

Fees may be charged by the online exchange for membership, on a transaction basis, or by a broker or market maker, as appropriate. In this case patent owners would receive only part of the sales price (e.g. a patent sold for $10,000 may net only $9,000 to the seller).

In a further embodiment, online auctions may be held in which patent application(s) and/or licenses are auctioned, wherein bidders are able to make bids on patent properties or shares of ownership of the patent properties as described above. Winning bidders are provided with their shares in exchange for consideration in the amount of the winning bid price, as known in the art of auctions.

The present invention also applies to an options market. An investor is able to purchase an option via the exchange for the right to purchase certain shares in intellectual property in the future for a given price. For example, an investor may pay $1,000 for the option to purchase or license a share of a patent application portfolio within 12 months at the share price of $10,000. If the investor believes that the $10,000 investment would be a good opportunity, then he would likely exercise the option and purchase the share accordingly. If not, he is not obligate to purchase the share but is unable to obtain the return of his $1,000 option purchase.

In another aspect of this invention, pharmaceuticals that must undergo the FDA approval process may be the subject of investment in the same manner that intellectual property is the subject of investments in the examples above. Thus, a new drug may enter the FDA approval process and be assigned a value X. As various stages of the approval process occur, the investment value will increase to X+A, X+B, X+C, etc., where A, B, C etc. are predetermined or variable increase (or decrease) factors that are added to X as the related phases of approval occur (or fail). In this way, a formulaic approach to investing, insuring, hedging in drugs undergoing FDA approval is achieved. This embodiment is particularly applicable with respect to charitable or other non-profit organizations that are looking to obtain funds to be invested in causes such as a cure for a disease such as cancer. For example, a charitable entity may solicit funds that are earmarked for use in research of a cure for cancer. The funds collected may then be invested as described herein, so that the value of the investment would vary as a function of various stages of the drug's development—including but not limited to research and development, FDA approval, etc. As the drug development process enjoys positive results, the value of the investment rises, and it sees negative results, the value of the investment falls. The determination of what qualifies as a positive result or a negative result, and the relative values ascribed thereto, are determined by the entity that configures and manages the system. For example, it may be determined that the value of the investment will increase by 10% once the proposed drug has been submitted for a clinical trial, etc.

The present invention provides for collaboration amongst various entities that wish to participate in this program. The participating entities may invest in desired amounts and will benefit from royalties earned by the intellectual property from licensees (or assignees) in like proportions. For example, two universities (University A and University B) may be interested in the same field (e.g. biotechnology). Each of these universities agree to obtain X units in the intellectual property instrument(s) in exchange for proportionate consideration, which may be cash (or like financial consideration) or which may be in the form of a contribution of intellectual property into the pool. As such, University A may contribute interests in intellectual property that it owns having a value X, and University B may contribute interests in intellectual property that it owns having a value Y. The interests contributed may be in the form of a license or an assignment of an ownership interest. In any event, these interests will be assigned a value, and the intellectual property contributions of these universities will have increased the value of the intellectual property pool investment instrument by from V to V+X+Y. In return, each university will receive a proportionate share of income from the intellectual property pool, which may be in the form of a future royalty stream, income from assignment, and the like.

In this example, the two entitles described are universities, but it is understood that any number of entities may participate, and that different types of entities other than universities may participate. For example, four entities may participate, which may include an individual, a corporation, a partnership, etc., in any combination whatsoever.

The present invention enables entities as described herein to spread out risks involved with so as to hedge technology and intellectual property liabilities, spread out risks involved with investing as well as implementing intellectual property through syndication and hedging techniques as described herein.

What is claimed is:

1. A method of assigning value to intellectual property comprising the steps of:
a) determining a starting price for said intellectual property prior to undergoing a prosecution phase;
b) associating an intrinsic price modifier with each of a plurality of prosecution factors, each prosecution factor related to a stage of prosecution of said intellectual property;
c) calculating a value of said intellectual property by adjusting the starting price by an intrinsic price modifier associated with a stage of prosecution that occurs for said intellectual property.

2. The method of claim 1 further comprising the step of adjusting the intrinsic price modifier by a multiplier associated with a number of occurrences of the stage of prosecution that occurs for said intellectual property.

3. The method of claim 1 wherein said intellectual property comprises a patent application.

4. The method of claim 3 wherein the stage of prosecution comprises one or more of:
a. a first office action
i. with all claims rejected,
ii. with all claims allowed, or
iii. with some claims allowed and some claims rejected
1. based on prior art reasons, or
2. based on formal reasons;
b. a response filed after an office action
i. with some claims allowed and the rejected claims cancelled,
ii. with some claims allowed and the claims rejected on prior art reasons amended and/or argued, or
iii. with some claims allowed and the claims rejected on formal reasons amended and/or argued;
c. a second office action
i. with the previously rejected claims allowed and the application ready for allowance, or
ii. with the rejected claims under final rejection;
d. a second response filed with the rejected claims cancelled and the application has some allowable claims;
e. an appeal being filed;
f. a continuation application being filed
g. all claims allowed; and
h. an appeal filed;
i. decided in favor of patentability, or
ii. decided not in favor of patentability.

5. The method of claim 1 executed by a computing device.

6. The method of claim 1 executed in association with an intellectual property exchange over a computer network.

7. The method of claim 6 wherein the intellectual property exchange comprises a server computer interconnected to the computer network, the server computer comprising means for storing a plurality of intellectual property listings, each of said listings comprising a description of intellectual property being offered for sale and a sales price ascertained in accordance with the value assigning steps.

8. The method of claim 7 wherein the intellectual property exchange further comprises a plurality of client computing devices interconnected to the network in selective communication with the server computer, wherein each client computing device allows an associated user to access the plurality of intellectual property listings and determine the associated sales price ascertained in accordance with the value assigning steps.

9. The method of claim 8 wherein a user is enabled to place an offer with the server computer to purchase for intellectual property listed thereon.

10. The method of claim 9 wherein a user is enabled to purchase a share of one or more pieces of intellectual property listed thereon.

11. The method of claim 1 further comprising the step of adjusting the starting price by an extrinsic price modifier unrelated to the prosecution process.
